(19) United States
(12) Patent Application Publication
(10) Pub. No.: US 2026/0299897 A1
(43) Pub. Date: Oct. 1, 2026

(54) PLANNING WITH LARGE LANGUAGE MODELS FOR CODE GENERATION WITH JOINTLY TRAINED TRANSFORMERS

(71) Applicant: INTERNATIONAL BUSINESS MACHINES CORPORATION, Armonk, NY (US)

(72) Inventors: Zhenfang Chen, Cambridge, MA (US); Yikang Shen, Cambridge, MA (US); Chuang Gan, Cambridge, MA (US); Xin Zhang, Chappaqua, NY (US); Shun Zhang, San Mateo, CA (US)

(21) Appl. No.: 19/093,634

(22) Filed: Mar. 28, 2025

(51) Int. Cl. G06F 8/35; G06F 11/3668

(52) U.S. Cl. CPC G06F 8/35; G06F 11/3684

(57) ABSTRACT

A method, system, and computer program product configured to perform operations including: responsive to receiving a natural language description of an application, generating corresponding computer code utilizing a code generation large language model (LLM) that includes a planning-guided transformer decoding (PG-TD) algorithm, wherein the PG-TD algorithm uses tree search-based planning in a decoding process of a code generation transformer that is trained using test cases generated by a test case generation transformer, and wherein the test case generation transformer is trained based on results generated by the code generation transformer.

### BACKGROUND

Aspects of the present invention relate generally to code generation using large language models (LLMs).

Transformer architecture is a deep learning architecture that is based on a multi-head attention mechanism. A decoder-based transformer model is an LLM that can be used for generative AI tasks such as text generation including code generation.

### SUMMARY

In a first aspect of the invention, there is a method including: responsive to receiving a natural language description of an application, generating corresponding computer code utilizing a code generation large language model (LLM) that includes a planning-guided transformer decoding (PG-TD) algorithm, wherein the PG-TD algorithm uses tree search-based planning in a decoding process of a code generation transformer that is trained using test cases generated by a test case generation transformer, and wherein the test case generation transformer is trained based on results generated by the code generation transformer.

In another aspect of the invention, there is a computer program product comprising one or more computer-readable storage media and program instructions stored on the one or more computer-readable storage media to perform operations comprising: responsive to receiving a natural language description of an application, generating corresponding computer code utilizing a code generation large language model (LLM) that includes a planning-guided transformer decoding (PG-TD) algorithm, wherein the PG-TD algorithm uses tree search-based planning in a decoding process of a code generation transformer that is trained using test cases generated by a test case generation transformer, and wherein the test case generation transformer is trained based on results generated by the code generation transformer.

In another aspect of the invention, there is a computer system comprising a processor set, one or more computer-readable storage media, and program instructions stored on the one or more computer-readable storage media to cause the processor set to perform operations comprising: responsive to receiving a natural language description of an application, generating corresponding computer code utilizing a code generation large language model (LLM) that includes a planning-guided transformer decoding (PG-TD) algorithm, wherein the PG-TD algorithm uses tree search-based planning in a decoding process of a code generation transformer that is trained using test cases generated by a test case generation transformer, wherein the test case generation transformer is trained based on results generated by the code generation transformer.

### BRIEF DESCRIPTION OF THE DRAWINGS

Aspects of the present invention are described in the detailed description which follows, in reference to the noted plurality of drawings by way of non-limiting examples of exemplary embodiments of the present invention.

FIG. 1 depicts a computing environment according to an embodiment of the present invention.

FIG. 2 shows a block diagram of an exemplary environment in accordance with aspects of the present invention.

FIG. 3 shows an exemplary use case involving a code generation problem for competitive programming in accordance with aspects of the present invention.

FIG. 4 illustrates a process of using a Monte-Carlo tree search algorithm in the transformer generation process for code generation in accordance with aspects of the present invention.

FIG. 5 shows pseudocode of the PG-TD algorithm for implementing the process of FIG. 4 in accordance with aspects of the present invention.

FIG. 6 shows two exemplary iterations of the PG-TD algorithm in accordance with aspects of the present invention.

FIG. 7 shows an exemplary step-by-step illustration of the PG-TD algorithm in accordance with aspects of the present invention.

FIGS. 8 and 9 show empirical results of the code generation LLM using the PG-TD algorithm in accordance with aspects of the present invention.

FIG. 10 shows an exemplary code generation example with code length penalty in accordance with aspects of the present invention.

FIG. 11 shows an exemplary code generation example with code comment encouragement in accordance with aspects of the present invention.

FIG. 12 shows an example of jointly training two transformers in accordance with aspects of the present invention.

FIGS. 13A-C show an example of learning to code by self-learning using a self-correction model in accordance with aspects of the present invention.

FIG. 14 shows a flowchart of an exemplary method in accordance with aspects of the present invention.

### DETAILED DESCRIPTION

Aspects of the present invention relate generally to code generation using LLMs and, more specifically, to generating programs that solve tasks described in natural language. Various embodiments include an LLM that is trained to generate computer code in response to an input comprising a natural language description of what process or task the computer code should perform. In embodiments, the LLM comprises a decoder-based transformer model that includes a novel Planning-Guided Transformer Decoding (PG-TD) algorithm as described herein.

Existing LLM-based code generation pipelines typically use beam search or sampling algorithms during the decoding process. Although the programs they generate achieve high token-matching-based scores, they often fail to compile, or they generate incorrect outputs. Some algorithms employ a decoding method that does not verify the generated code using test cases. Other algorithms make use of test cases to verify and filter the generated code, but these suffer from poor efficiency.

Implementations of the invention provide a solution to these problems by introducing a novel transformer decoding algorithm, referred to as Planning-Guided Transformer Decoding (PG-TD), that uses a planning algorithm to do lookahead search and guide the transformer to generate better programs. In various embodiments, instead of simply optimizing the likelihood of the generated sequences, the transformer makes use of a planner to generate candidate programs and test them on public test cases. The transformer can therefore make more informed decisions and generate tokens that will eventually lead to higher-quality programs. Embodiments also include a mechanism that shares information between the transformer and the planner to make the algorithm computationally efficient.

Various implementations of the invention utilize the PG-TD, which is a model-agnostic algorithm that uses tree search-based planning in the transformer decoding process to generate better codes. Implementations improve the computational efficiency of the algorithm by sharing information between the tree search algorithm and beam search. Implementations also optimize various objectives, including correctness, lengths of codes, numbers of lines of comments, etc.

In accordance with aspects of the invention, an apparatus includes a pretrained transformer model for code generation, a tree search-based planning algorithm, and an efficient caching algorithm that improves the efficiency of the whole framework. The transformer model may comprise a GPT-based model that is pretrained using codes that are available online and using a coding challenge problem dataset. In embodiments, the tree search-based algorithm is a Monte-Carlo tree search algorithm. The Monte-Carlo tree search algorithm may be an iterative tree search algorithm that consists of selection, expansion, evaluation, and back-propagation. In various embodiments, the pass rates on a set of test cases are used as the reward function. The Monte-Carlo tree search algorithm may be configured to use the pretrained transformer model to find high-likely tokens in the selection step. The Monte-Carlo tree search algorithm may be configured to use the transformer beam search algorithm to generate high-likely sequences in the evaluation step. In embodiments, the transformer beam search algorithm and the Monte-Carlo tree search algorithm share information to make the whole framework more efficient. In embodiments, the tree structure and beam search results are cached and can be used for the following steps of Monte-Carlo tree search algorithm.

Implementations of the invention are necessarily rooted in computer technology. For example, the step of generating computer code utilizing a code generation LLM is computer-based and cannot be performed in the human mind. Using a trained LLM to generate an output (such as computer code) involves accessing millions (or billions) of bytes of data from computer memory and utilizing that data in computations in near real time (e.g., only a few seconds). Given this scale and complexity, it is simply not possible for the human mind, or for a person using pen and paper, to perform the number of calculations involved in training and/or using an LLM.

More specifically, modern deep learning models, including large language models (LLMs) used for generative artificial intelligence (AI) tasks such as dialogue systems, summarization, and code generation, are built from artificial neural networks that comprise multiple layers of interconnected nodes called neurons. Each neuron has an activation function which is a mathematical operation performed on data received from the previous layer, whose output informs the input fed to the following layer. Classic feed-forward neural networks (FFNs) process information by progressively passing input data from neurons in one layer to neurons in the following layer until it reaches an outer layer where final predictions occur. Some neural network architectures incorporate additional elements, like the self-attention mechanisms of transformer models, that capture additional patterns and dependencies in input data. The connections between different layers and neurons are mediated by learnable model parameters which are variable weights and biases that amplify or diminish the influence a given part of the network's output has on other parts of the network. A deep learning model “learns” by adjusting these parameters, using optimization algorithms like gradient descent, in a way that increases the accuracy of its predictions. First generation Generative Pre-trained Transformer (GPT) LLMs, which debuted in the year 2018, typically include hundreds of millions of parameters (e.g., 117 million parameters). Second generation GPT LLMs, which debuted in the year 2019, typically include around a billion parameters (e.g., 1.5 billion parameters). Third generation GPT LLMs, which debuted in the year 2020, typically include tens to hundreds of billions of parameters (e.g., anywhere from 30 billion to 175 billion parameters). Fourth generation GPT LLMs, which debuted in the year 2023, are estimated to include trillions of parameters (e.g., 1.7 trillion parameters). Each parameter typically requires 2 bytes of computer memory for storage and usage with the trained model. Therefore, using a trained LLM to generate an output (e.g., as with dialogue systems, summarization, and story writing) involves accessing at least hundreds of millions (and possibly billions or trillions) of bytes of data from computer memory and utilizing that data in computations in near real time (e.g., only a few seconds). Given this scale and complexity, it is simply not possible for the human mind, or for a person using pen and paper, to perform the number of calculations involved in using a trained LLM to generate an output.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer-readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer-readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as code generation LLM of block 200. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

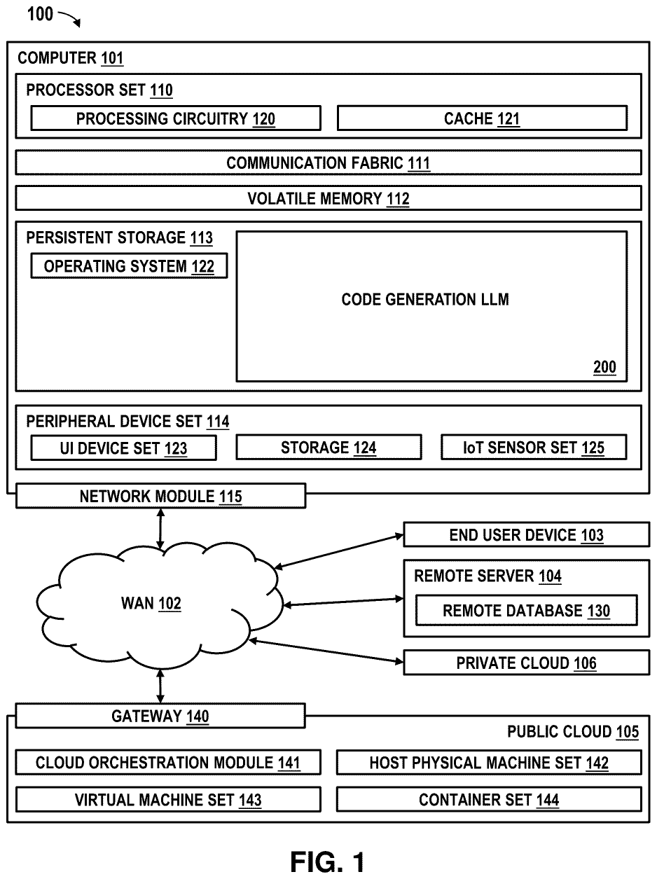

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer-readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer-readable program instructions are stored in various types of computer-readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer-readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

CLOUD COMPUTING SERVICES AND/OR MICROSERVICES (not separately shown in FIG. 1): private and public clouds 106 are programmed and configured to deliver cloud computing services and/or microservices (unless otherwise indicated, the word “microservices” shall be interpreted as inclusive of larger “services” regardless of size). Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider's systems, and back. In some embodiments, cloud services may be configured and orchestrated according to as “as a service” technology paradigm where something is being presented to an internal or external customer in the form of a cloud computing service. As-a-Service offerings typically provide endpoints with which various customers interface. These endpoints are typically based on a set of APIs. One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

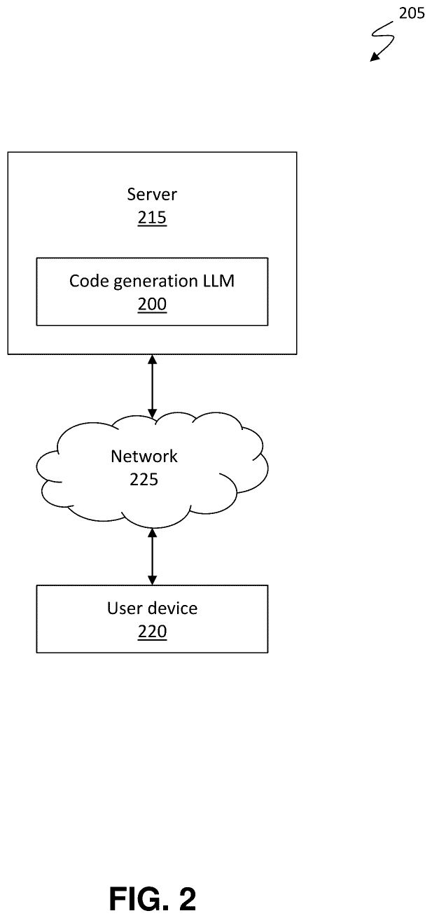

FIG. 2 shows a block diagram of an exemplary environment 205 in accordance with aspects of the invention. In embodiments, the environment 205 includes the code generation LLM 200 of FIG. 1 loaded to a server 215. In embodiments, the code generation LLM 200 defines a decoder-based transformer model that is configured to receive an input (e.g., from a user device 220 via a network 225) and generate an output based on the input. In various examples, the decoder-based transformer model defined by code generation LLM 200 is a generative AI model that that is trained to generate an output comprising computer code in response to an input comprising a natural language description of what process or task the computer code should perform. In one exemplary configuration, the server 215 comprises one more instances of the computer 101 of FIG. 1. In another exemplary configuration, the server 215 comprises one or more virtual machines or containers running on one more instances of the computer 101 of FIG. 1. In embodiments, the user device 220 comprises one or more instances of the EUD 103 of FIG. 1 and the network 225 comprises the WAN 102 of FIG. 1.

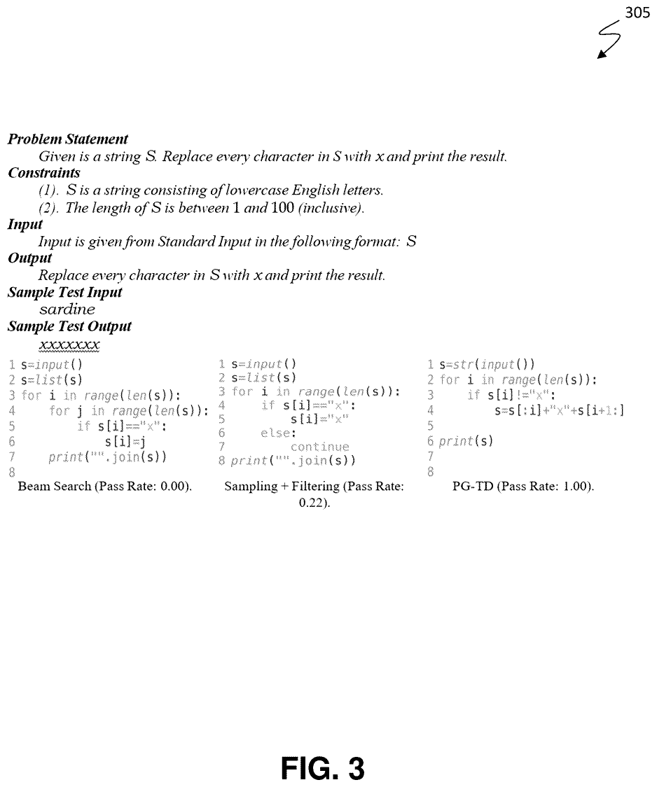

An exemplary use case involving a code generation problem 305 for competitive programming is shown in FIG. 3. In this example, an agent (e.g., a code generation model competing in the competition) is given the natural language description of a coding problem. It requires the agent to understand the problem description and generate a program that solves the problem. In this example, the agent has access to a set of test cases, where a test case is a pair of input-output strings. Given the input string, the agent is expected to generate a program that produces an output that exactly matches the test case's output string. The objective is to generate a program that passes a highest number of test cases. To determine if the agent is able to generate programs that generalize to unseen test cases, the test cases may be divided into public test cases and private test cases. In this example, the agent can only access the public test cases during the program generation process, while the private test cases are used to evaluate the programs it generates.

Conventional transformer models have been widely applied for code generation thanks to their capacity in sequence-to-sequence modeling. In the transformer's generation process, beam search and sampling are adopted to generate code sequences. However, these algorithms cannot easily optimize an objective different from what it is trained on (usually the similarity to the reference solutions). As a result, one cannot directly use these generation algorithms to generate programs aiming to pass more test cases.

On the other hand, a planning algorithm can directly optimize the pass rate or any desirable programming objective. To use a planning algorithm, one may formulate the code generation problem as a Markov decision process (MDP). In this formulation, a state “s” is the concatenation of the problem description and a partial or complete program, where a complete program ends with a special terminal token. An action “a” is a token in the vocabulary set of the transformer. There is a special termination action (the terminal token) that indicates that the agent believes the program is complete. The transition function deterministically concatenates a state “s” with a token “a” and an episode ends when the agent takes the termination action. The reward of state “s” is the pass rate of the program on the public test cases when “s” is a complete program (i.e., when the last token of “s” is the terminal token). The reward of a partial program is always 0.

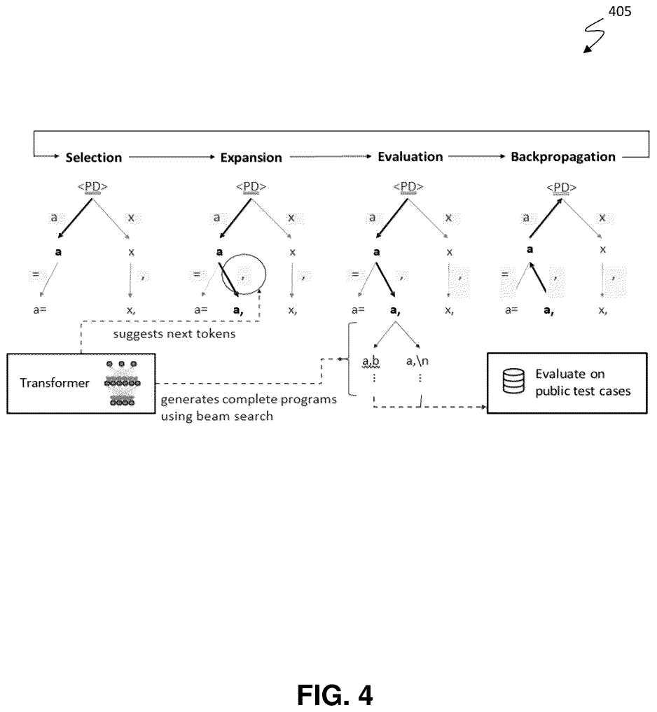

In contrast to the conventional transformer models and planning algorithms described above, various embodiments in accordance with aspects of the present disclosure utilize a tree search-based planning algorithm inspired by Monte-Carlo tree search (MCTS), illustrated in FIG. 4. In particular, FIG. 4 illustrates a process 405 of using a Monte-Carlo tree search algorithm in the transformer generation process for code generation in accordance with aspects of the present invention. In FIG. 4, “<PD>” stands for problem description. Intuitively, the tree search algorithm maintains a tree structure where nodes correspond to states and edges correspond to actions. The algorithm starts from the root node (the initial state) and searches the state space to find terminal states with high rewards. It maintains 1) the number of times each node is visited and 2) a value function that maintains the maximum reward obtained by starting in node (or state) “s” and taking action “a”. In some embodiments, the algorithm visits and expand nodes with either higher values (as they lead to higher-quality programs) or with smaller visit numbers (as they are under-explored). As described herein, embodiments integrate the tree search algorithm in the generation process of the transformer of the code generation LLM 200 of FIG. 2 to improve the code generation results (e.g., generate better computer code in response to a natural language input).

In accordance with aspects of the present invention, the code generation LLM 200 of FIG. 2 includes a transformer generation algorithm where a tree search algorithm is used to perform lookahead planning. In embodiments, because a tree search algorithm alone may not be able to find high-quality codes due to the large search space, the conventional transformer beam search algorithm and the next-token probabilities provided by the pre-trained transformer are used by the tree search algorithm to guide the search process.

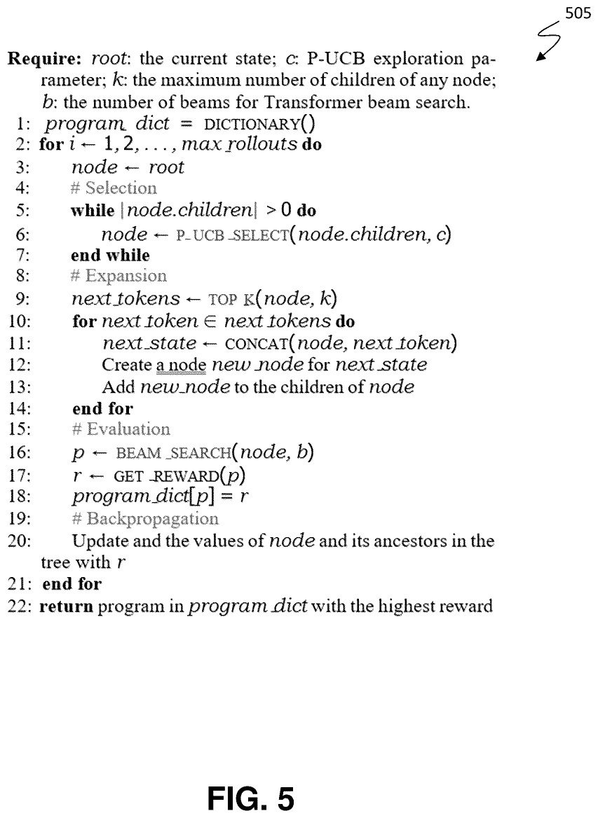

FIG. 5 shows pseudocode 505 of the PG-TD for implementing the process 405 of FIG. 4 in accordance with aspects of the present invention. In embodiments, the PG-TD algorithm follows the same framework as the MCTS algorithm. Aspects of the present disclosure focus on how the transformer is used in the tree search steps.

In the selection step of process 405 of FIG. 4 and lines 4-7 of pseudocode 505 of FIG. 5, embodiments use a “P-UCB” algorithm, which is a variation of the upper confidence bound (UCB) algorithm, to select which branch of the tree we want to explore. In P-UCB, embodiments weigh the exploration term by the probability of the next tokens determined by the transformer. In this manner, the tree search selects higher-probability tokens more often. The selection algorithm is parameterized by an exploration parameter “c” where a higher “c” value leads to more exploration.

In the expansion step of process 405 of FIG. 4 and lines 8-14 of pseudocode 505 of FIG. 5, after a node in the tree is selected, embodiments select the possible next tokens and add the corresponding next states as new nodes to its children list (for succinctness, a node also refers to the state that it represents). Sampling a random token as in the MCTS may very likely cause a syntax error. To account for this, embodiments call the function “TOP_K” to get the most likely next tokens, where TOP_K(s, k) is a function that returns the k most likely next tokens starting from “s” where “k” is the maximum number of children that any node may have. The corresponding “k” number of next states are the concatenations of the current state with each of the next tokens suggested by the transformer. These next states are added to the children list of the current node as shown at lines 9-14 of pseudocode 505 of FIG. 5.

In the evaluation step of process 405 of FIG. 4 and lines 15-18 of pseudocode 505 of FIG. 5, embodiments evaluate the selected node. In some cases that node may still be a partial program. Embodiments cannot directly evaluate the quality of a partial program as it is not known how it will be completed and how many test cases it will pass. Here, embodiments use the transformer again by calling the “BEAM SEARCH” function to generate a complete program from the current node, where BEAM SEARCH(s, b) is a function that generates a sequence using the transformer beam search algorithm with the prefix “s” and beam size “b”. Embodiments run the generated program on the public test cases to get its reward and set it to be the value of the node as shown at lines 16-17 of pseudocode 505 of FIG. 5. In embodiments, this value is backpropagated up in the tree so that the values of its ancestors are updated as shown in the process 405 of FIG. 4 and at lines 19-20 of pseudocode 505 of FIG. 5.

In accordance with aspects of the present invention, the transformer beam search algorithm and the Monte-Carlo tree search algorithm of the code generation LLM 200 of FIG. 2 share information. It can be understood from FIGS. 4 and 5 that the algorithm described above may include repeated computations. In embodiments, the transformer beam search algorithm also implicitly builds a tree structure, which can be used by future iterations of tree search. Embodiments improve the algorithm's efficiency by sharing information in the transformer beam search algorithm with tree search.

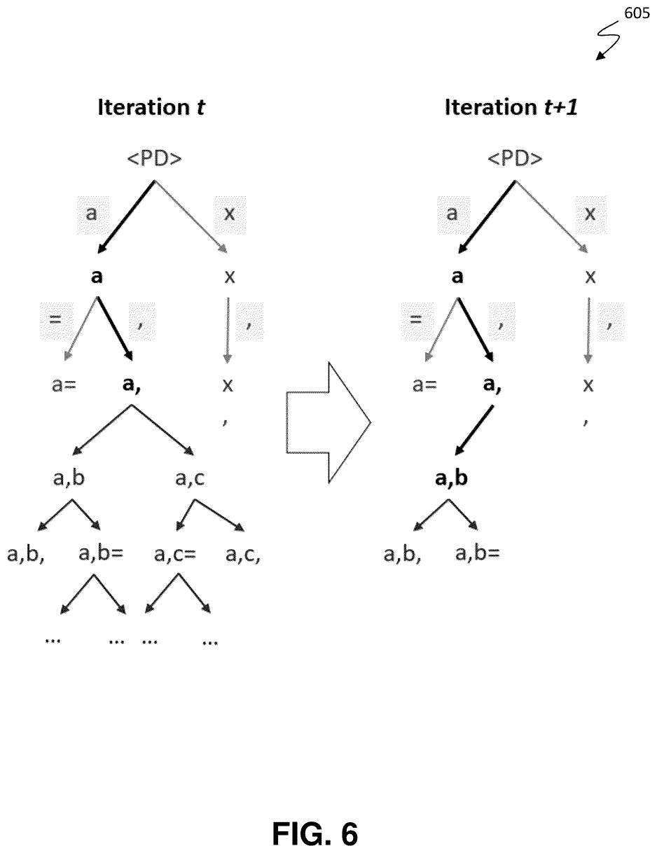

FIG. 6 shows two exemplary iterations 605 of the PG-TD algorithm in accordance with aspects of the present invention. FIG. 6 illustrates how the transformer beam search algorithm and MCTS share the same tree structure and how the beam search algorithm caches the information and shares it with MCTS in accordance with aspects of the present invention. In embodiments, in the evaluation step of the t-th iteration shown on the left side of FIG. 6, the transformer beam search algorithm implicitly builds a tree to find the most likely sequences within a beam. Because embodiments only keep “b” partial programs in the beam, it is a tree where only “b” nodes with the highest likelihood are expanded at each level (in the illustration, b=2). Other nodes are dropped and no longer considered by the beam search algorithm. In the (t+1)-st iteration shown on the left side of FIG. 6, if the tree search algorithm selects “a”, such a state is already visited in the transformer beam search in the t-th iteration. When the algorithm needs to find the top-k most likely next tokens, such information is already obtained in the t-th iteration and can be reused without re-computation. Embodiments cache the tree structure generated by the transformer beam search algorithm, which may be referred to as tree structure caching.

Embodiments may also cache the complete programs generated during the PG-TD evaluation step. In the evaluation step of the t-th iteration of FIG. 6, if the greedily optimal sequence is “a, b=. . . ”, then in the (t+1)-st iteration, to generate a sequence starting with “a, b”, the transformer beam search algorithm will generate the same sequence “a, b=. . . ” as before. To improve the efficiency of the “BEAM SEARCH” function, embodiments cache the sequences that have been generated during the evaluation step. In the evaluation step of future iterations, the PG-TD algorithm checks if the current state matches the prefix of any sequence that has been generated before and uses the generated sequence directly without calling the transformer beam search function. This may be referred to as implementation sequence caching.

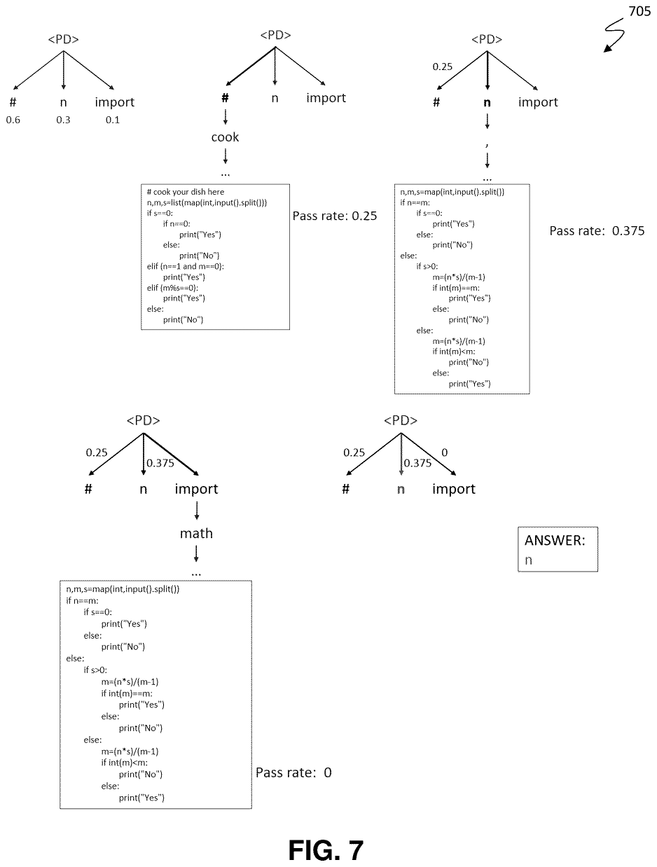

FIG. 7 shows an exemplary step-by-step illustration 705 of the PG-TD algorithm in accordance with aspects of the present invention. In embodiments, and as illustrated in the example shown in FIG. 7, during each pass the pre-trained LLM determines the top-k most likely next tokens (e.g., as described above) and the MCTS rollouts the sequence and evaluates their performance with test cases and code execution. In embodiments, the LLM regards the pass rate as the reward and backpropagates these rewards into their parent nodes to decide which node to expand in the next iteration.

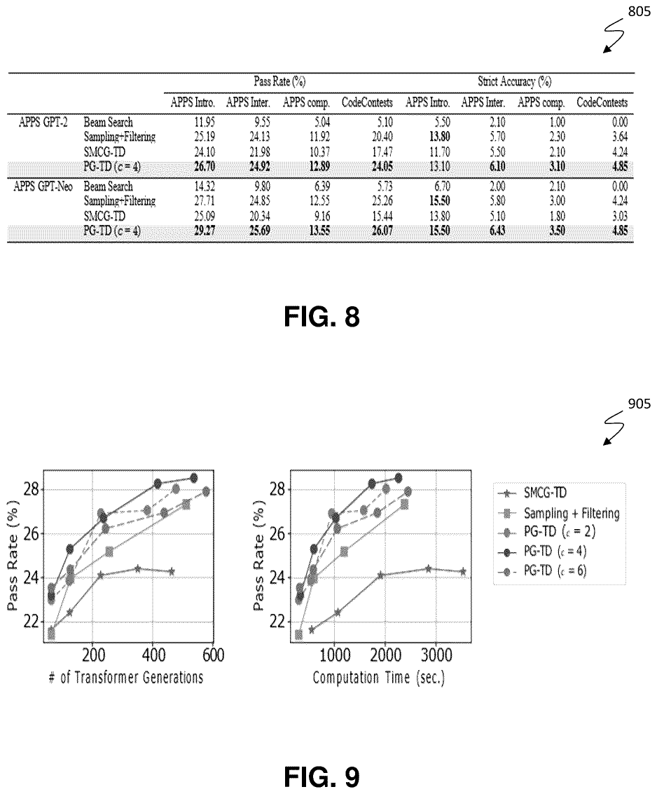

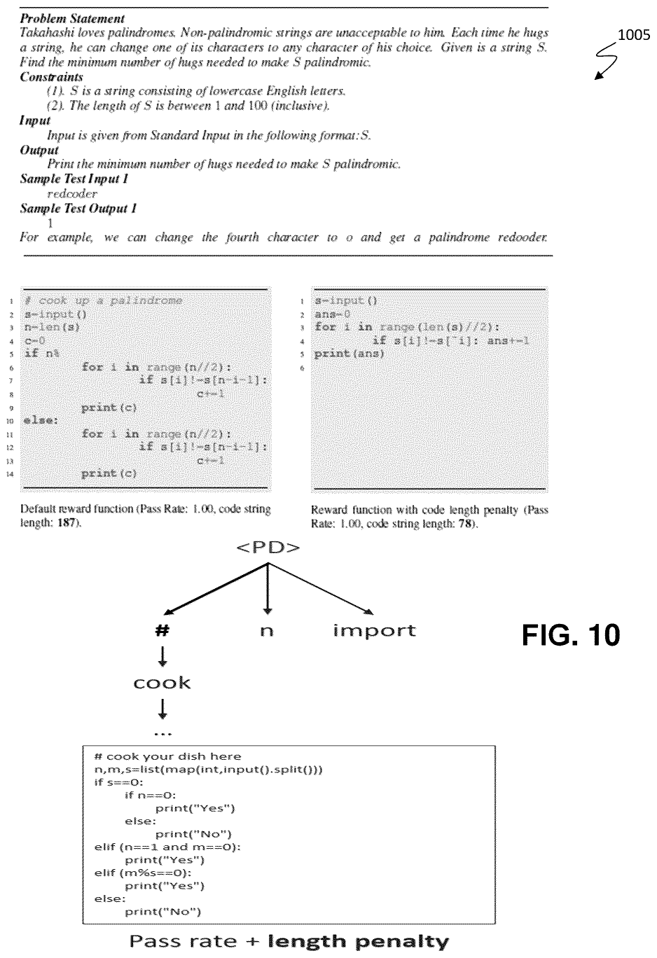

FIGS. 8 and 9 show empirical results of the code generation LLM 200 using the PG-TD algorithm in accordance with aspects of the present invention. FIG. 8 shows a table 805 of pass rate and strict accuracy percentages of the code generation LLM 200 using the PG-TD algorithm in accordance with aspects of the present invention (e.g., represented by PG-TD) versus other baseline algorithms (e.g., Beam Search, Sampling+Filtering, and SMCG-TD). FIG. 9 shows plots 905 of pass rate percentage per number of transformer generations and per computation time of three different implementations of the code generation LLM 200 using the PG-TD algorithm in accordance with aspects of the present invention (e.g., represented by PG-TD) versus other baseline algorithms (e.g., Sampling+Filtering and SMCG-TD).

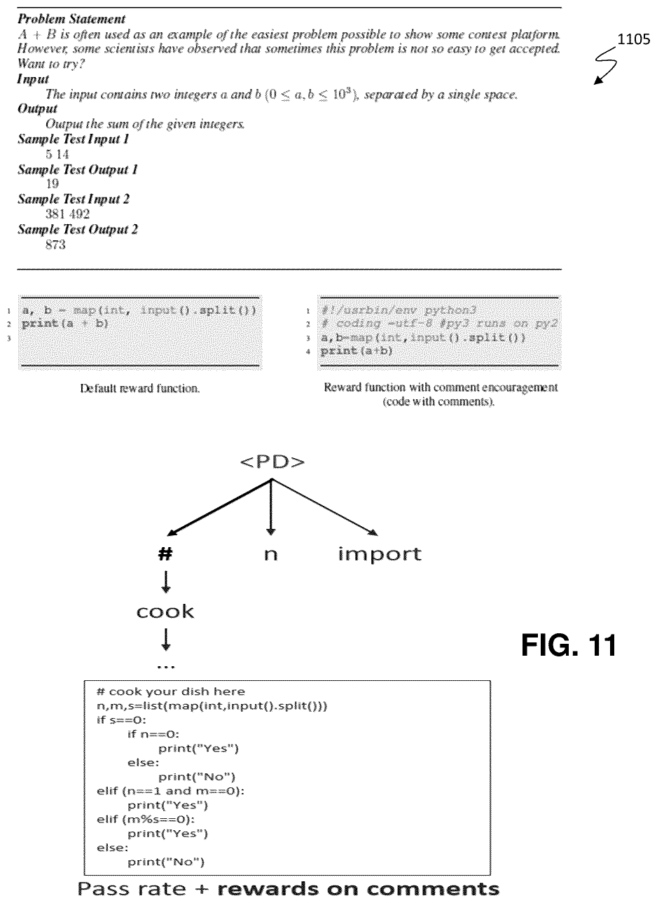

FIG. 10 shows an exemplary code generation example 1005 with code length penalty in accordance with aspects of the present invention. The problem description is shown on the top. The programs generated by an embodiment of PG-TD without code length penalty and an embodiment of PG-TD with code length penalty are shown below the problem description. In this manner, it is seen that implementations of the invention can be used to generate more concise code by utilizing a code length penalty reward.

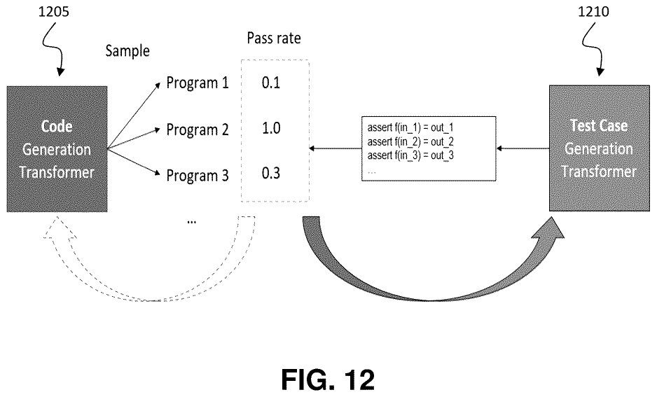

FIG. 11 shows an exemplary code generation example 1105 with code comment encouragement in accordance with aspects of the present invention. The problem description is shown on the top. The programs generated by an embodiment of PG-TD without comment encouragement and an embodiment of PG-TD with comment encouragement are shown below the problem description. In this manner, it is seen that implementations of the invention can be used to generate can generate codes with more comments by using the code comment encouragement reward.

The code generation LLM 200 using the PG-TD algorithm in accordance with aspects of the present invention has been described thus far with respect to generating code for programming challenges. However, implementations are not limited to generating code for programming challenges, and implementations can be used for other LLM based solutions such as programming translation and mathematical problem solving.

In various embodiments, test cases may be learned from the task description or may be automatically generated using test case generation software.

In various embodiments, the decoding procedure does not necessarily expand each token but instead only expands those tokens with lower certainty. In this manner, implementations may comprise expanding only a subset of all tokens without expanding all the tokens.

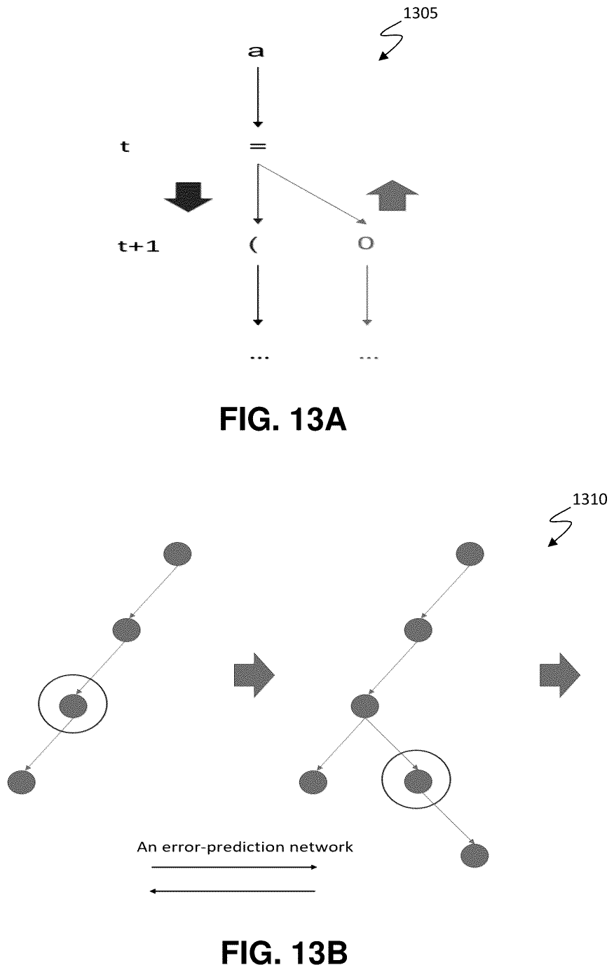

FIG. 12 shows an example of jointly training two transformers in accordance with aspects of the present invention. In embodiments, code generation transformer 1205 is a decoder-based transformer model that is defined by the code generation LLM 200 of FIG. 2 and that is trained to generate computer code in response to an input comprising a natural language description of what process or task the computer code should perform. In embodiments, test case generation transformer 1210 is a transformer model that is configured to generatively create test cases that may be used to train the code generation transformer 1205 portion of the code generation LLM 200. In accordance with aspects of the invention, the test case generation transformer is trained based on results generated by the code generation transformer 1205. In embodiments, the code generation transformer 1205 and the test case generation transformer 1210 are jointly trained by: (i) training the code generation transformer 1205 by tuning the code generation transformer 1205 using one or more programs generated by the code generation transformer 1205 that have relatively high pass rates on the test cases that are generated by the test case generation transformer 1210; and (ii) training the test case generation transformer 1210 by tuning the test case generation transformer 1210 using respective ones of the test cases that result in programs generated by the code generation transformer 1205 that have relatively high pass rates. As used herein, programs that have relatively high pass rates may comprise ones of the programs that have a pass rate above a threshold value, which may be predefined or dynamically adjusted. Tuning the transformers 1205 and 1210 may include adjusting values of respective ones of the learnable model parameters (e.g., weights and biases) in the transformers 1205 and 1210 using an ML training algorithm.

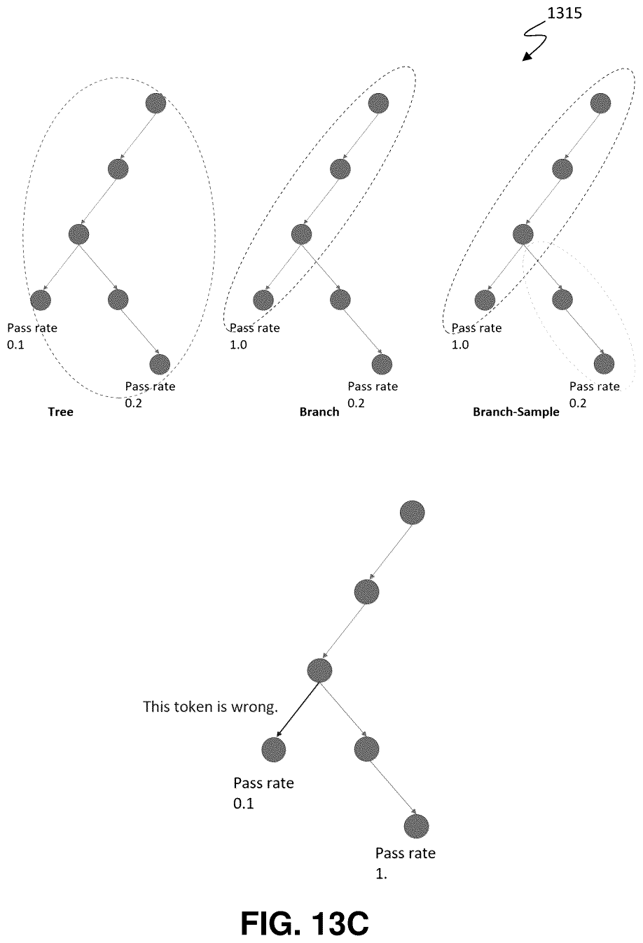

FIGS. 13A-C show an example of learning to code by self-learning using a self-correction model 1305 in accordance with aspects of the present invention. In embodiments, the self-correction model locates incorrect tokens using the entropy of the next-token probabilities, regenerates new sequences from the located token using a tree search, and fine tunes the transformer defined by the code generation LLM 200 of FIG. 2 if the new sequence is a correct solution. FIG. 13B shows an example of an error prediction network 1310 usable in the model. In embodiments, the error prediction network backpropagates using a reinforcement learning (RL) loss function with the goal being a minimum number of steps to reach a correct program. FIG. 13C shows an example of expansion 1315 using the model.

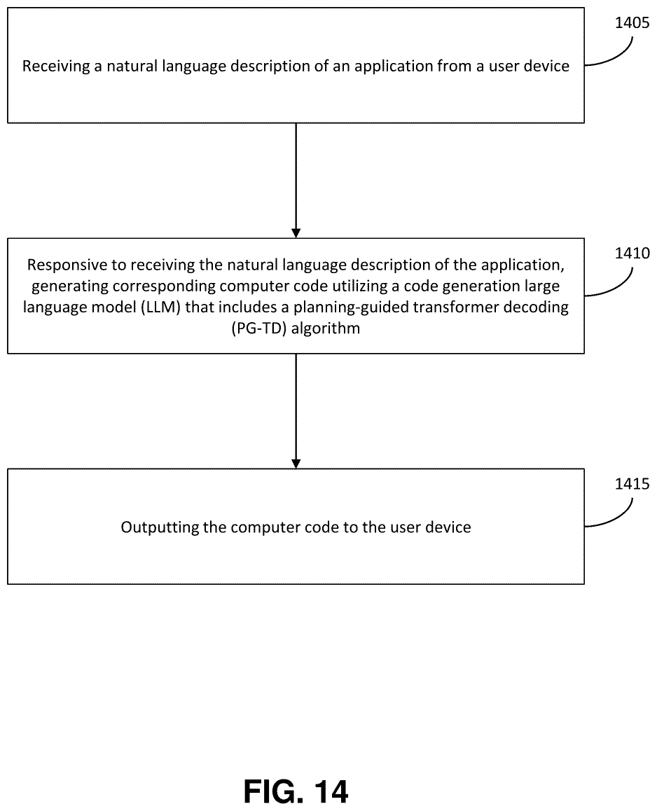

FIG. 14 shows a flowchart of an exemplary method in accordance with aspects of the present invention. Steps of the method (also referred to as operations) may be carried out in the environment of FIG. 2 and are described with reference to elements depicted in FIG. 2.

At step 1405 the server 215 receives a natural language description of an application from the user device 220. At step 1410, responsive to receiving the natural language description of the application, the server 215 generates corresponding computer code utilizing a code generation large language model (e.g., the code generation LLM 200) that includes a planning-guided transformer decoding (PG-TD) algorithm, e.g., by providing the natural language description of the application as an input to the code generation LLM 200. In embodiments, and as described herein, the PG-TD algorithm uses tree search-based planning in a decoding process of a code generation transformer 1205 that is trained using test cases generated by a test case generation transformer 1210, wherein the test case generation transformer 1210 is trained based on results generated by the code generation transformer 1205. At step 1415 the server 215 outputs the code generated at step 1410 to the user device 220.

In embodiments of the method, the tree search-based planning utilizes a Monte-Carlo tree search algorithm. In embodiments of the method, the Monte-Carlo tree search algorithm is an iterative tree search algorithm that consists of selection, expansion, evaluation, and back-propagation. In embodiments of the method, pass rates on a set of test cases are used as the reward function. In embodiments of the method, the Monte-Carlo tree search algorithm uses the pretrained transformer model to find high-likely tokens in selection. In embodiments of the method, the Monte-Carlo tree search algorithm uses the transformer beam search algorithm to generate high-likely sequences in evaluation. In embodiments of the method, the transformer beam search algorithm and the Monte-Carlo tree search algorithm share information. In embodiments of the method, training the code generation transformer comprises tuning the code generation transformer using one or more programs generated by the code generation transformer that have relatively high pass rates on the test cases. In embodiments of the method, training the test case generation transformer comprises tuning the test case generation transformer using respective ones of the test cases that result in programs generated by the code generation transformer that have relatively high pass rates. In embodiments, the method further comprises expanding only a subset of all tokens without expanding all the tokens.

In embodiments, a service provider could offer to perform the processes described herein. In this case, the service provider can create, maintain, deploy, support, etc., the computer infrastructure that performs the process steps in accordance with aspects of the invention for one or more customers. These customers may be, for example, any business that uses technology. In return, the service provider can receive payment from the customer(s) under a subscription and/or fee agreement and/or the service provider can receive payment from the sale of advertising content to one or more third parties.

In still additional embodiments, implementations provide a computer-implemented method, via a network. In this case, a computer infrastructure, such as computer 101 of FIG. 1, can be provided and one or more systems for performing the processes in accordance with aspects of the invention can be obtained (e.g., created, purchased, used, modified, etc.) and deployed to the computer infrastructure. To this extent, the deployment of a system can comprise one or more of: (1) installing program code on a computing device, such as computer 101 of FIG. 1, from a computer readable medium; (2) adding one or more computing devices to the computer infrastructure; and (3) incorporating and/or modifying one or more existing systems of the computer infrastructure to enable the computer infrastructure to perform the processes in accordance with aspects of the invention.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method, comprising:
responsive to receiving a natural language description of an application, generating corresponding computer code utilizing a code generation large language model (LLM) that includes a planning-guided transformer decoding (PG-TD) algorithm, wherein the PG-TD algorithm uses tree search-based planning in a decoding process of a code generation transformer that is trained using test cases generated by a test case generation transformer, and wherein the test case generation transformer is trained based on results generated by the code generation transformer.

2. The method of claim 1, wherein the tree search-based planning utilizes a Monte-Carlo tree search algorithm.

3. The method of claim 2, wherein the Monte-Carlo tree search algorithm is an iterative tree search algorithm that comprises selection, expansion, evaluation, and back-propagation.

4. The method of claim of 3, wherein pass rates on a set of test cases are used as a reward function.

5. The method of claim 3, wherein the Monte-Carlo tree search algorithm uses a pretrained transformer model to find high-likely tokens in selection.

6. The method of claim 3, wherein the Monte-Carlo tree search algorithm uses a transformer beam search algorithm to generate high-likely sequences in evaluation.

7. The method of claim 6, wherein the transformer beam search algorithm and the Monte-Carlo tree search algorithm share information.

8. The method of claim 1, wherein training the code generation transformer comprises tuning the code generation transformer using one or more programs generated by the code generation transformer that have relatively high pass rates on the test cases.

9. The method of claim 1, wherein training the test case generation transformer comprises tuning the test case generation transformer using respective ones of the test cases that result in programs generated by the code generation transformer that have relatively high pass rates.

10. The method of claim 1, further comprising expanding only a subset of all tokens without expanding all the tokens.

11. A computer program product comprising:
one or more computer-readable storage media; and
program instructions stored on the one or more computer-readable storage media to perform operations comprising:
responsive to receiving a natural language description of an application, generating corresponding computer code utilizing a code generation large language model (LLM) that includes a planning-guided transformer decoding (PG-TD) algorithm, wherein the PG-TD algorithm uses tree search-based planning in a decoding process of a code generation transformer that is trained using test cases generated by a test case generation transformer, and wherein the test case generation transformer is trained based on results generated by the code generation transformer.

12. The computer program product of claim 11, wherein the tree search-based planning utilizes a Monte-Carlo tree search algorithm.

13. The computer program product of claim 12, wherein the Monte-Carlo tree search algorithm is an iterative tree search algorithm that comprises selection, expansion, evaluation, and back-propagation.

14. The computer program product of claim of 13, wherein pass rates on a set of test cases are used as a reward function.

15. The computer program product of claim 13, wherein the Monte-Carlo tree search algorithm uses a pretrained transformer model to find high-likely tokens in selection.

16. The computer program product of claim 13, wherein the Monte-Carlo tree search algorithm uses a transformer beam search algorithm to generate high-likely sequences in evaluation.

17. The computer program product of claim 16, wherein the transformer beam search algorithm and the Monte-Carlo tree search algorithm share information.

18. A computer system comprising:
a processor set;
one or more computer-readable storage media; and
program instructions stored on the one or more computer-readable storage media to cause the processor set to perform operations comprising:
responsive to receiving a natural language description of an application, generating corresponding computer code utilizing a code generation large language model (LLM) that includes a planning-guided transformer decoding (PG-TD) algorithm, wherein the PG-TD algorithm uses tree search-based planning in a decoding process of a code generation transformer that is trained using test cases generated by a test case generation transformer, and wherein the test case generation transformer is trained based on results generated by the code generation transformer.

19. The computer system of claim 18, wherein the tree search-based planning utilizes a Monte-Carlo tree search algorithm.

20. The computer system of claim 19, wherein the Monte-Carlo tree search algorithm is an iterative tree search algorithm that comprises selection, expansion, evaluation, and back-propagation.
